(19) United States
(12) Patent Application Publication
(10) Pub. No.: US 2019/0242720 A1
(43) Pub. Date: Aug. 8, 2019

(54) SYSTEMS AND METHODS FOR CONSTRUCTING SPATIAL ACTIVITY ZONES

(71) Applicant: Topos Inc., Brooklyn, NY (US)

(72) Inventors: Will Shapiro, New York, NY (US); Mahir Yavuz, Brooklyn, NY (US)

(73) Assignee: Topos Inc., Brooklyn, NY (US)

(21) Appl. No.: 16/256,901

(22) Filed: Jan. 24, 2019

Related U.S. Application Data
(60) Provisional application No. 62/627,583, filed on Feb. 7, 2018.

(51) Int. Cl. G01C 21/36; G01C 21/34; G06F 16/909; G06F 16/906; G06Q 50/16; H04W 4/021

(52) U.S. Cl. CPC G01C 21/3679; G01C 21/3492; H04W 4/021; G06F 16/906; G06Q 50/16; G06F 16/909

(57) ABSTRACT

According to some aspects, a system is provided to perform obtaining point-of-interest data indicating a label and a location for one or more of a plurality of points of interest, determining, using the point-of-interest data, commute times among at least some of the plurality of points of interest, wherein a first commute time between two of the at least some of the plurality of points of interest indicates an estimated time for commuting between the two points of interest for a particular mode of transportation, clustering, using the commute times and labels indicated by the point-of-interest data, the plurality of points of interest into a set of point-of-interest clusters, wherein substantially all points of interest in each cluster have a common label, and determining a set of spatial zones corresponding to the set of point-of-interest clusters by identifying a spatial boundary for each cluster in the set of point-of-interest clusters.

### CROSS REFERENCE TO RELATED APPLICATIONS

This application claims priority under 35 U.S.C. § 119(e) to U.S. Provisional Patent Application Ser. No. 62/627,583, entitled “SYSTEMS AND METHODS FOR CONSTRUCTING SPATIAL ACTIVITY ZONES,” filed on Feb. 7, 2018, which is herein incorporated by reference in its entirety.

### BACKGROUND

Conventional approaches to understanding the characteristics and offerings of parts of a city typically include analyzing the city by an administrative boundary, such as zip code, or a neighborhood boundary. For example, zip code 90210 in Beverly Hills, Calif., may indicate a high standard of living, partly made famous by a popular teen TV drama series in the 1990s of the same name. In another example, the Hell's Kitchen neighborhood in New York City may indicate a high density of ethnic restaurants.

### SUMMARY

Administrative or neighborhood boundaries are fixed and cannot be adapted to varying needs for visitors, residents, or companies to better understand the characteristics and offerings of parts of a city they may be interested in. In some embodiments, a system is provided for algorithmically constructing continuous spatial zones pertaining to specific activities and habits such as nightlife, shopping, or spending time with children using artificial intelligence. Such zones may be referred to as spatial zones or spatial activity zones in this disclosure. It is appreciated that such zones may be used for several different purposes including, but not limited to, recommending specific hotels or apartments for people looking to move or travel to a given city or neighborhood, guiding commercial and residential real estate development and investment, informing scaling strategy for companies and restaurant groups that require brick and mortar locations, and empowering recommendation for location based services and technologies including mobile phone applications, augmented reality applications, and autonomous vehicles.

With respect to commercial real estate, the spatial zones may be used to help guide decisions relating to where to buy or lease commercially zoned spaces. For example, coworking companies, such as WEWORK, BREATHER, or KNOTEL, tend to cater to the “millennial” demographic segment. Millennials may have strong preferences for specific lifestyles and urban environments. To this end, spatial zones may be constructed that capture different aspects of that lifestyle. For example, “hipster” zones, “artisanal” zones, and “health” zones are three examples of spatial zones that may be relevant to millennial customers. Choosing a location guided by the construction of such zones and analyzing where they overlap may ensure that different facets of millennial culture are present in the urban environment surrounding the selected coworking location, thereby enticing customers to join the space. Furthermore, the use of such zones may be particularly advantageous with respect to arbitrage, as some of these zones (such as “hipster” zones) often occur in urban areas that may be undervalued in relation to other urban areas.

In another example, an “athleisure” retail brand may be looking to open a new brick and mortar location in a new city. While it may be common practice to locate stores primarily in relation to competitors, spatial zones may allow for a more nuanced and expansive view of the city, revealing a larger range of opportunities that may help with arbitrage or lack of available commercially zoned spaces in areas near competitors. “Athleisure” is a lifestyle that is associated both with specific athletic apparel brands (e.g., LULULEMON, ATHLETA, and OUTDOOR VOICES) and with specific cuisines (e.g., juice bars, salad bars, and matcha tea stores) and athletic activities (e.g., yoga studios, spinning studios, and barre studios). For a new athleisure apparel brand, particularly one that may not have the resources of more established brands, such as ATHLETA (owned by GAP and having a $13.31B market cap) or LULULEMON (having $10.58B market cap), it may be advantageous to consider an expanded set of possibilities for brick and mortar locations rather than just the area surrounding its direct competitors, which is likely to be expensive.

According to some aspects, a system is provided comprising at least one computer hardware processor and at least one non-transitory computer-readable storage medium storing processor-executable instructions that, when executed by the at least one computer hardware processor, cause the at least one computer hardware processor to perform obtaining point-of-interest data indicating a label and a location for each of one or more points of interest in a plurality of points of interest, determining, using the point-of-interest data, commute times among at least some of the plurality of points of interest, wherein a first commute time between two points of interest of the at least some of the plurality of points of interest indicates an estimated amount of time for commuting between the two points of interest for a particular mode of transportation, clustering, using the commute times and labels indicated by the point-of-interest data, the plurality of points of interest into a set of point-of-interest clusters, wherein substantially all points of interest in each cluster in the set have a common label, and determining a set of spatial zones corresponding to the set of point-of-interest clusters by identifying a spatial boundary for each cluster in the set of point-of-interest clusters.

According to some embodiments, the particular mode of transportation is one of walking, running, driving, riding a bicycle, and taking public transportation.

According to some embodiments, the location includes one or more of global positioning satellite (GPS) location, a latitude coordinate, and a longitude coordinate.

According to some embodiments, the clustering uses one of a k-means clustering algorithm, a hierarchical clustering algorithm, a distribution-based clustering algorithm, and a density-based clustering algorithm.

According to some embodiments, obtaining the point-of-interest data comprises receiving metadata for a respective point of interest and applying one or more business rules to the received metadata to determine the label for the respective point of interest.

According to some embodiments, obtaining the point-of-interest data comprises receiving metadata for a respective point of interest, parsing, using natural language processing, the metadata, and determining the label for the respective point of interest based on the parsed metadata.

According to some embodiments, obtaining the point-of-interest data comprises generating a topic model based on a corpus of text relating to the plurality of points of interest, determining a topic within the topic model, wherein the topic includes a grouping of one or more words relating to the plurality of points of interest, identifying a portion of the corpus of text relating to the respective point of interest, constructing, based on the portion of the corpus of text, a bag of words representing word frequency within the portion of the corpus of text, normalizing the bag of words with respect to a number of occurrences in the corpus of text relating to the respective point of interest, and assigning the topic as a label for the respective point of interest based on the topic being represented above a specified threshold in the normalized bag of words.

According to some embodiments, obtaining the point-of-interest data comprises determining the label for a respective point of interest based on a visual representation of the respective point of interest.

According to some embodiments, the visual representation includes one or more of exterior photography, interior photography, logo design, and website design.

According to some embodiments, determining the first commute time comprises calculating a distance between the two points of interest and multiplying the distance with an average transportation time for the particular mode of transportation to determine the first commute time.

According to some embodiments, the calculation of the distance is based on Vincenty's formula.

According to some embodiments, determining the set of spatial zones comprises including a buffer to one or more edges of the spatial boundary, wherein a width of the buffer is determined such that a point in the spatial boundary is at most a specified threshold time from a point of interest within the spatial boundary.

According to some embodiments, the spatial boundary is a minimum envelope that includes all points of interest within the respective spatial zone.

According to some embodiments, the minimum envelope that includes all points of interest within the respective spatial zone is a concave hull of all points of interest within the respective spatial zone.

According to some embodiments, the processor-executable instructions further cause the at least one computer hardware processor to perform determining a time-based clustering threshold for a maximum time to commute from an arbitrary point within a spatial zone to another arbitrary point within the spatial zone, wherein clustering the plurality of points of interest includes clustering, using the commute times, labels indicated by the point-of-interest data, and the time-based clustering threshold, the plurality of points of interest into the set of point-of-interest clusters.

According to some embodiments, the determined set of spatial zones are input into a machine learning model to predict one or more spatial zones suitable for a real estate company.

According to some aspects, a method is provided for using at least one computer hardware processor to perform obtaining point-of-interest data indicating a label and a location for each of one or more points of interest in a plurality of points of interest, determining, using the point-of-interest data, commute times among at least some of the plurality of points of interest, wherein a first commute time between two points of interest of the at least some of the plurality of points of interest indicates an estimated amount of time for commuting between the two points of interest for a particular mode of transportation, clustering, using the commute times and labels indicated by the point-of-interest data, the plurality of points of interest into a set of point-of-interest clusters, wherein substantially all points of interest in each cluster in the set have a common label, and determining a set of spatial zones corresponding to the set of point-of-interest clusters by identifying a spatial boundary for each cluster in the set of point-of-interest clusters.

According to some aspects, at least one non-transitory computer-readable storage medium is provided for storing processor-executable instructions that, when executed by the at least one computer hardware processor, cause the at least one computer hardware processor to perform a system is provided comprising at least one computer hardware processor and at least one non-transitory computer-readable storage medium storing processor-executable instructions that, when executed by the at least one computer hardware processor, cause the at least one computer hardware processor to perform obtaining point-of-interest data indicating a label and a location for each of one or more points of interest in a plurality of points of interest, determining, using the point-of-interest data, commute times among at least some of the plurality of points of interest, wherein a first commute time between two points of interest of the at least some of the plurality of points of interest indicates an estimated amount of time for commuting between the two points of interest for a particular mode of transportation, clustering, using the commute times and labels indicated by the point-of-interest data, the plurality of points of interest into a set of point-of-interest clusters, wherein substantially all points of interest in each cluster in the set have a common label, and determining a set of spatial zones corresponding to the set of point-of-interest clusters by identifying a spatial boundary for each cluster in the set of point-of-interest clusters.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

Various non-limiting embodiments of the technology will be described with reference to the following figures. It should be appreciated that the figures are not necessarily drawn to scale.

FIG. 1 is a diagram of a distributed system in accordance with some embodiments of the technology described herein;

FIG. 2 is a diagram of a process for determining a spatial zone in accordance with some embodiments of the technology described herein;

FIG. 3 is a diagram of an exemplary process for generating a label for a respective point of interest in accordance with some embodiments of the technology described herein;

FIGS. 4-7 are diagrams of exemplary spatial zones generated in accordance with some embodiments of the technology described herein;

FIG. 8 is a diagram of steps for determining a spatial zone in accordance with some embodiments of the technology described herein;

FIG. 9 is a diagram of a process for determining a commute time between a pair of points of interest in accordance with some embodiments of the technology described herein;

FIGS. 10-14 are diagrams of an example process for clustering a set of points of interest into point-of-interest clusters in accordance with some embodiments of the technology described herein;

FIG. 15 shows an example implementation for constructing a spatial zone in accordance with some embodiments of the technology described herein; and

FIG. 16 shows an example computer system for determining a spatial zone in accordance with some embodiments of the technology described herein.

### DETAILED DESCRIPTION

As discussed above, conventional approaches to understanding the characteristics and offerings of parts of a city rely on administrative or neighborhood boundaries, which are fixed and cannot be adapted to varying needs for visitors, residents, or companies to better understand the characteristics and offerings of parts of a city they may be interested in.

The inventors have recognized that a system for algorithmically constructing continuous spatial zones based on commute time pertaining to, e.g., specific activities and habits, such as nightlife, shopping, or spending time with children, may enable users and systems to better understand the characteristics and offerings of parts of a city. The commute time may vary based on the specific activity or habit and a suitable mode of transportation. For example, for “nightlife” activity, the commute time may be based on walking as people may visit multiple establishments (such as restaurants, bars, late night bodegas, pool halls, etc.) over the course of a night on the town. In another example, with respect to commercial real estate, the spatial zones may be used to help guide decisions around where to buy or lease commercially zoned spaces. Coworking companies, such as WEWORK, BREATHER, or KNOTEL, tend to cater to the “millennial” demographic segment, and spatial zones may be constructed that capture different aspects of that lifestyle. For example, “hipster” zones, “artisanal” zones, and “health” zones are three examples of spatial zones that may be relevant to millennial customers. Choosing a location guided by the construction of such zones and analyzing where they overlap may ensure that different facets of millennial culture are present in the urban environment surrounding the selected coworking location, thereby enticing customers to join the space.

In particular, the described systems and methods provide for obtaining point-of-interest data indicating a label and a location for each of one or more points of interest in a plurality of points of interest, determining, using the point-of-interest data, commute times among at least some of the plurality of points of interest, wherein a first commute time between two points of interest of the at least some of the plurality of points of interest indicates an estimated amount of time for commuting between the two points of interest for a particular mode of transportation, clustering, using the commute times and labels indicated by the point-of-interest data, the plurality of points of interest into a set of point-of-interest clusters, wherein substantially all points of interest in each cluster in the set have a common label, and determining a set of spatial zones corresponding to the set of point-of-interest clusters by identifying a spatial boundary for each cluster in the set of point-of-interest clusters.

The described systems and methods improve computerized search technology by enabling automated construction of continuous spatial zones based on commute time. The described systems and methods replace conventional zoning mechanisms, such as zip codes and neighborhoods, that are fixed and cannot be modified to address the problem of understanding the characteristics and offerings of parts of a city. By providing for construction of spatial zones to capture different aspects of interest to the user and within a certain commute time, the described systems and methods may enable users and systems to better understand the characteristics and offerings of parts of a city.

The described systems and methods provide a particular solution to the problem of understanding the characteristics and offerings of parts of a city. The described systems and methods provide a particular way for automated construction of continuous spatial zones based on commute time by obtaining point-of-interest data indicating a label and a location for each of one or more points of interest in a plurality of points of interest, determining, using the point-of-interest data, commute times among at least some of the plurality of points of interest, wherein a first commute time between two points of interest of the at least some of the plurality of points of interest indicates an estimated amount of time for commuting between the two points of interest for a particular mode of transportation, clustering, using the commute times and labels indicated by the point-of-interest data, the plurality of points of interest into a set of point-of-interest clusters, wherein substantially all points of interest in each cluster in the set have a common label, and determining a set of spatial zones corresponding to the set of point-of-interest clusters by identifying a spatial boundary for each cluster in the set of point-of-interest clusters. Moreover, the spatial zones produced by the described systems and methods may power predictive machine learning models for a variety of applications, e.g., for retail, commercial and residential real estate companies.

The described systems and methods may be used for several different purposes including, but not limited to, recommending specific hotels or apartments for people looking to move or travel to a given city or neighborhood, guiding commercial and residential real estate development and investment, informing scaling strategy for companies and restaurant groups that require brick and mortar locations, and empowering recommendation for location based services and technologies including mobile phone applications, augmented reality applications, and autonomous vehicles. In one implementation, given an identified geographical area (e.g., as provided by a user via a query), one or more spatial zones may be constructed and returned to the referencing program or user.

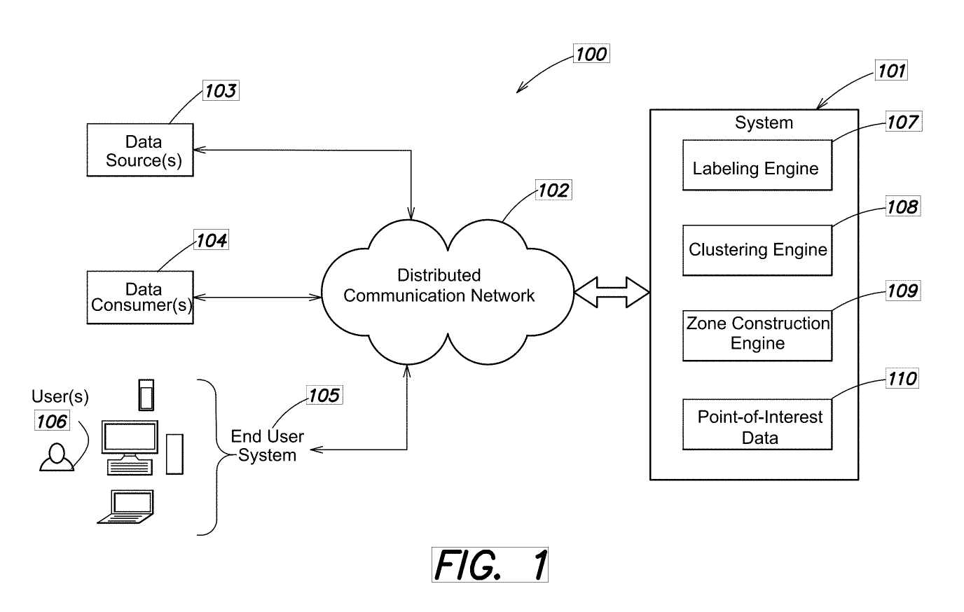

FIG. 1 shows a processing system 100 that is capable of constructing spatial zones for one or more sets of points of interest. In particular, system 101 is coupled to one or more end user systems 105 through a distributed communication network 102. Further, system 101 may be in communication with one or more data consumers 104 that are adapted to use and/or interpret one or more spatial zones. Furthermore, system 101 may interpret one or more data sources 103 for the purposes of obtaining point-of-interest data indicating a label and a location for each of one or more points of interest in a plurality of points of interest, determining, using the point-of-interest data, commute times among at least some of the plurality of points of interest, wherein a first commute time between two of the at least some of the plurality of points of interest indicates an estimated amount of time for commuting between the two points of interest for a particular mode of transportation, clustering, using the commute times and labels indicated by the point-of-interest data, the plurality of points of interest into a set of point-of-interest clusters, wherein substantially all points of interest in each cluster in the set have a common label, and determining a set of spatial zones corresponding to the set of point-of-interest clusters by identifying a spatial boundary for each cluster in the set of point-of-interest clusters.

System 101 may include one or more elements including a labeling engine 107, a clustering engine 108, a zone construction engine 109, and point-of-interest data 110. In one embodiment, the labeling engine 107 is capable of determining for a point of interest, e.g., a bar serving “craft beers,” a label that defines a related set of points of interest, e.g., “hipster.” Labeling engine may evaluate one or more pieces of data provided by one or more data sources (e.g., data sources 103). In one embodiment, the clustering engine 108 is capable of clustering a set of points of interest, such as points of interest in a given neighborhood, into one or more clusters of points of interest sharing a label, e.g., “hipster,” “artisanal,” and/or “health.” In one embodiment, system 101 includes a recommendation engine 107 which is capable of providing a ranked list of locations that are similar to an indicated location. Further, system 101 may collect and store point-of-interest data 110 which may include, for example, information relating to various points of interest within particular geographic regions.

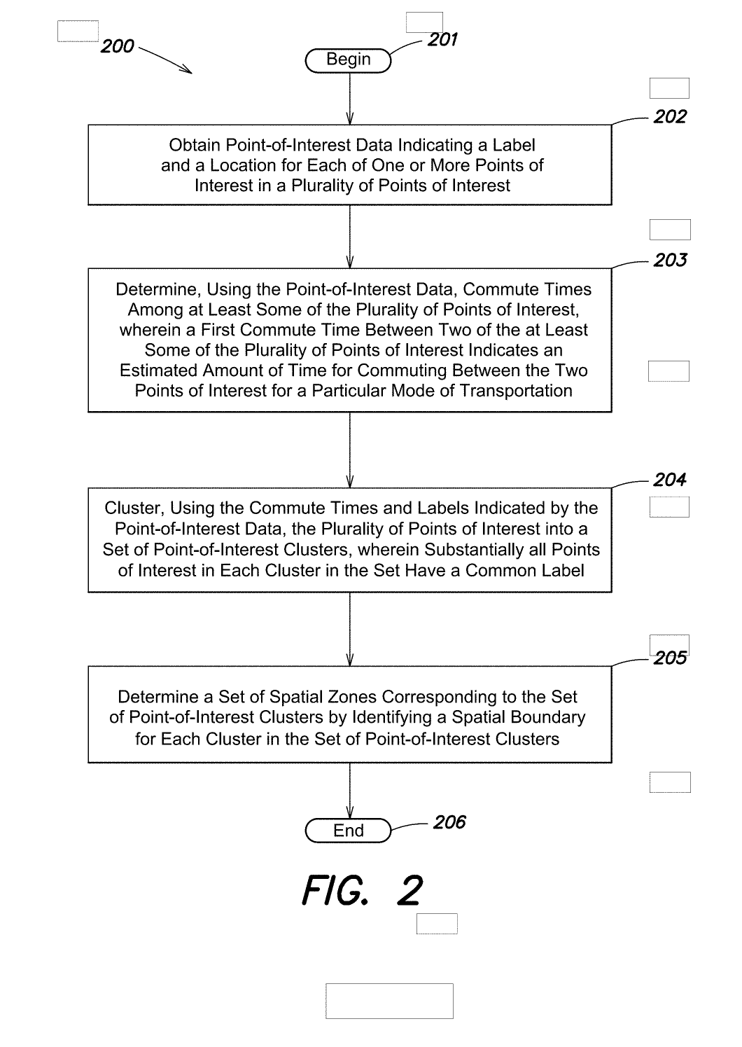

FIG. 2 shows a diagram of a process for determining a spatial zone according to one embodiment. In particular, at block 201, process 200 begins. At block 202, the system obtains point-of-interest data indicating a label and a location for each of one or more points of interest in a plurality of points of interest. For example, the system may receive point-of-interest data for, e.g., bars, restaurants, stores, establishments, parks, etc., and an associated set of information, such as metadata (indicating a label), Latitude and Longitude coordinates (indicating a location), and/or other suitable information. For example, the point-of-interest data may include metadata indicating labels such as “bar,” “pool hall,” and “restaurant.” Some or all points of interest labeled with such labels may also have metadata pertaining to opening hours available. Additionally, or alternatively, a group of the points of interest may have metadata indicating the label “Nightlife” based on such a group of points of interest having available opening hours data. At block 203, the system determines, using the point-of-interest data, commute times among at least some of the plurality of points of interest. A first commute time between two of the at least some of the plurality of points of interest indicates an estimated amount of time for commuting between the two points of interest for a particular mode of transportation. The commute time may be based on time spent walking, driving, commuting via train, or another suitable mode of transportation. At block 204, the system clusters, using the commute times and labels indicated by the point-of-interest data, the plurality of points of interest into a set of point-of-interest clusters, wherein substantially all points of interest in each cluster in the set have a common label, such as “Nightlife.” At block 205, the system determines a set of spatial zones corresponding to the set of point-of-interest clusters by identifying a spatial boundary for each cluster in the set of point-of-interest clusters. The boundary of a spatial zone may be defined as the minimum envelope that contains all POIs within the given zone. For example, the boundary of a spatial zone may be defined by constructing the Concave Hull of the set of points contained within a given zone. At block 206, process 200 ends.

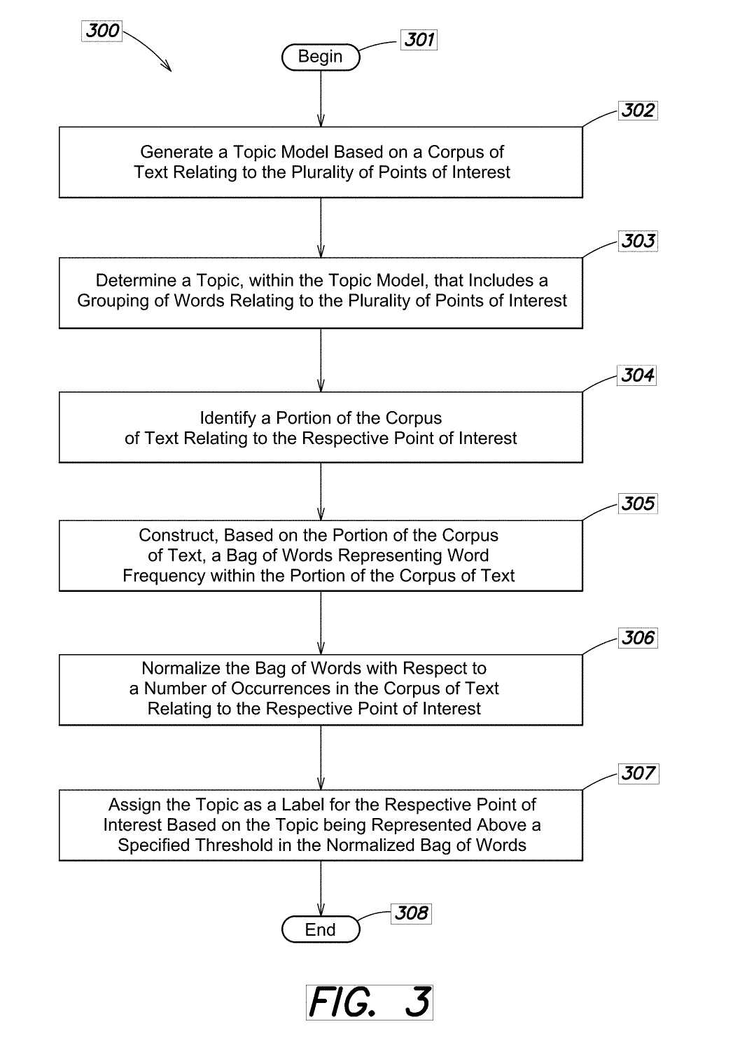

FIG. 3 shows a diagram of an example process for generating a label for a respective point of interest according to one embodiment. In particular, at block 301, process 300 begins. At block 302, the system generates a topic model based on a corpus of text relating to the plurality of points of interest. For example, the corpus of text may include all of the restaurant reviews of restaurants in New York City written over the past 5 years by the New York Times. At block 303, the system determines a topic within the topic model. The topic includes a grouping of one or more words relating to the plurality of points of interest. For example, the topic may include a cluster of words or groupings of words that generally pertain to hipster culture, for example, “craft cocktails,” “craft beers,” “natural wine,” “local,” “artisanal,” “fermented,” and other suitable topics. At block 304, the system identifies a portion of the corpus of text relating to the respective point of interest. For example, the system may identify all restaurant reviews pertaining to the point of interest. At block 305, the system constructs, based on the portion of the corpus of text, a bag of words representing word frequency within the portion of the corpus of text. At block 306, the system normalizes the bag of words with respect to a number of occurrences in the corpus of text relating to the respective point of interest. For example, the system may normalize this bag of words in relation to the number of restaurant reviews about the point of interest ingested, the total number of words ingested about the point of interest, or another suitable metric. At block 307, the system assigns the topic as a label for the respective point of interest based on the topic being represented above a specified threshold in the normalized bag of words. For example, if the normalized bag of words is determined to have an over-representation of hipster words (based on the specified threshold), the “hipster” label may be applied to the point of interest. At block 308, process 300 ends.

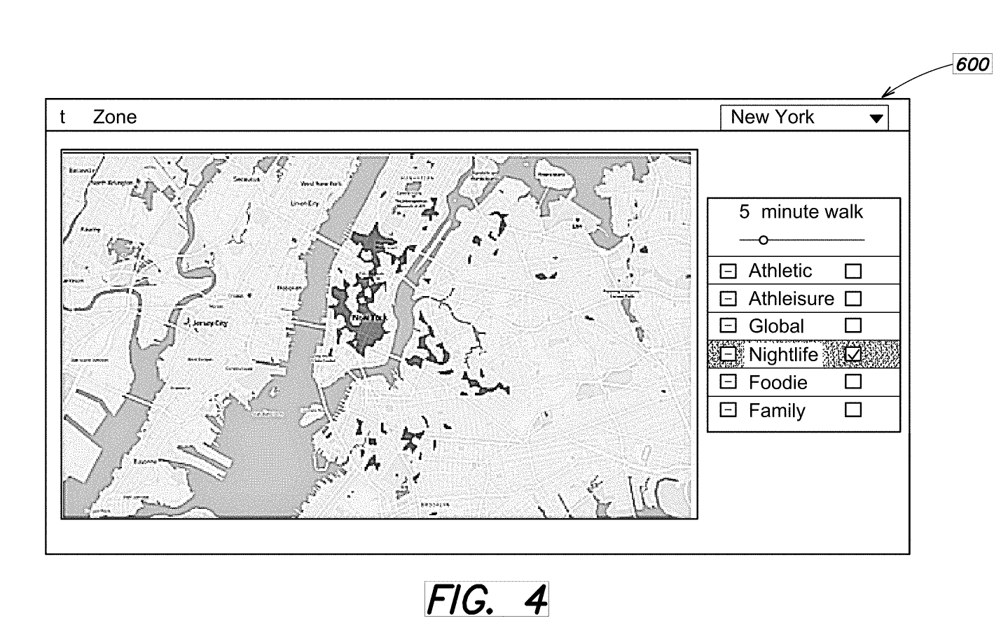

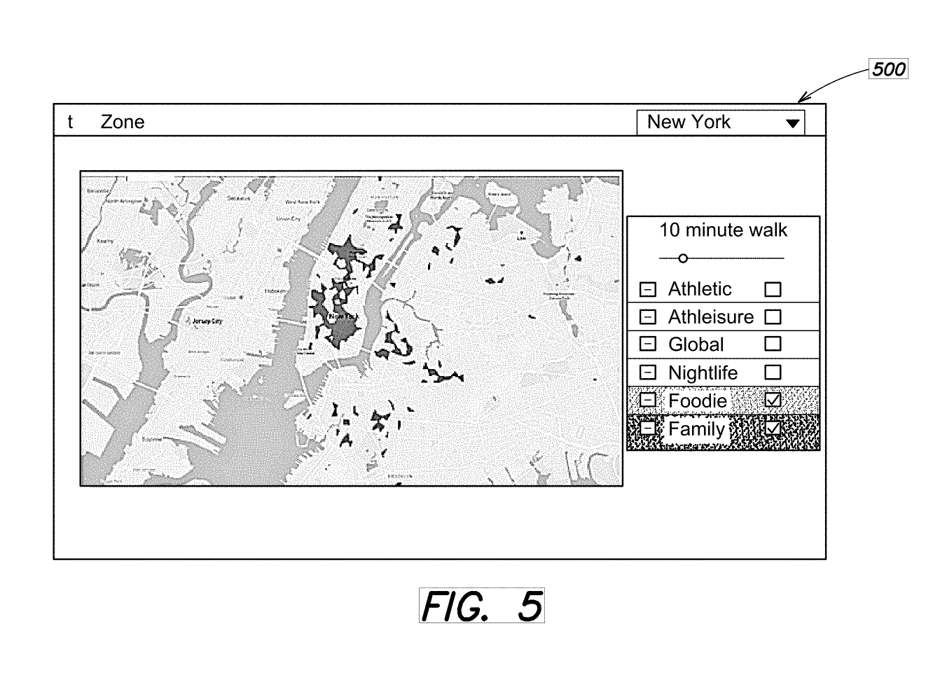

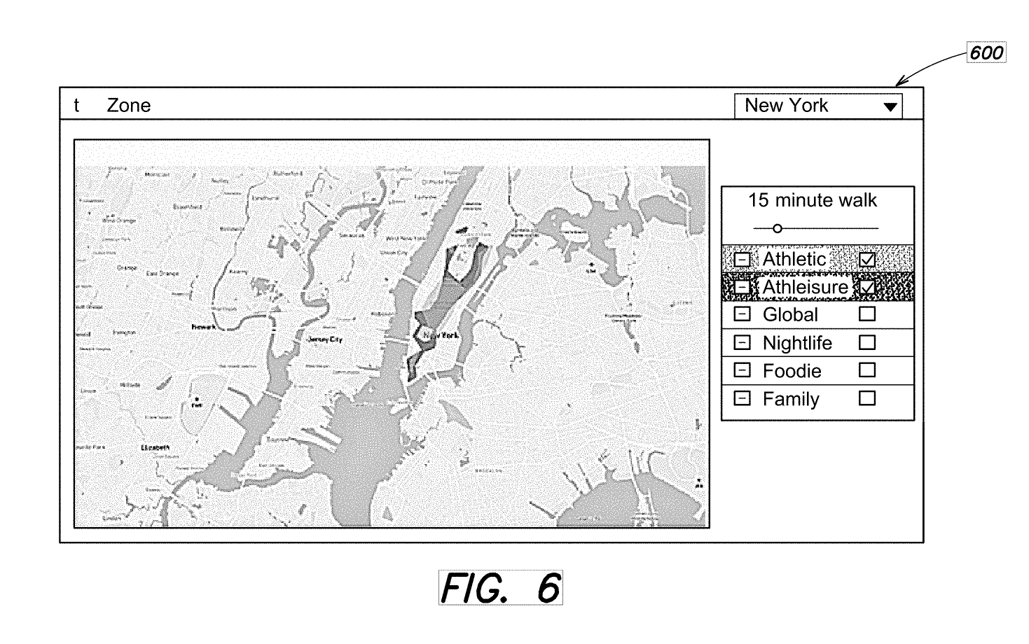

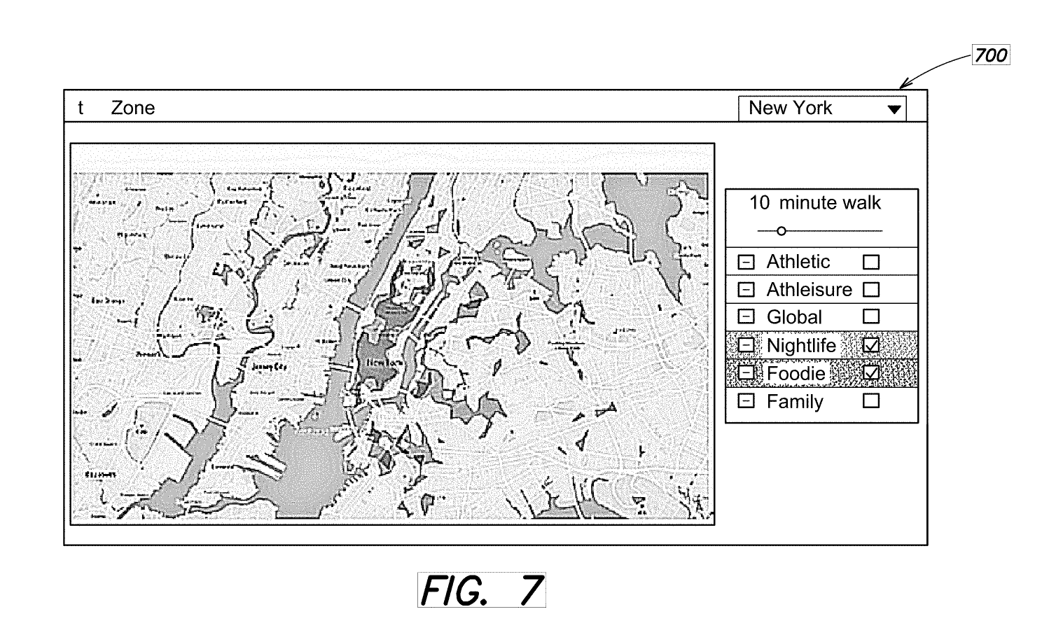

As discussed above, spatial zones may be used for several different purposes, including but not limited to, recommending specific hotels or apartments for people looking to move or travel to a given city or neighborhood, guiding commercial and residential real estate development and investment, informing scaling strategy for companies and restaurant groups that require brick and mortar locations and empowering recommendation for location based services and technologies including mobile phone applications, augmented reality applications and autonomous vehicles. FIGS. 4-7 show diagrams of exemplary spatial zones generated according to various embodiments. For example, FIG. 4 shows a “Nightlife” zone with a commute time of five minutes via walking. In another example, FIG. 5 shows overlapping “Foodie” and “Family” zones with a commute time of 10 minutes via walking. In yet another example, FIG. 6 shows overlapping “Athletic” and “Athleisure” zones with a commute time of 15 minutes via walking. In yet another example, FIG. 7 shows overlapping “Foodie” and “Nightlife” zones with a commute time of 10 minutes via walking.

### EXAMPLE IMPLEMENTATION

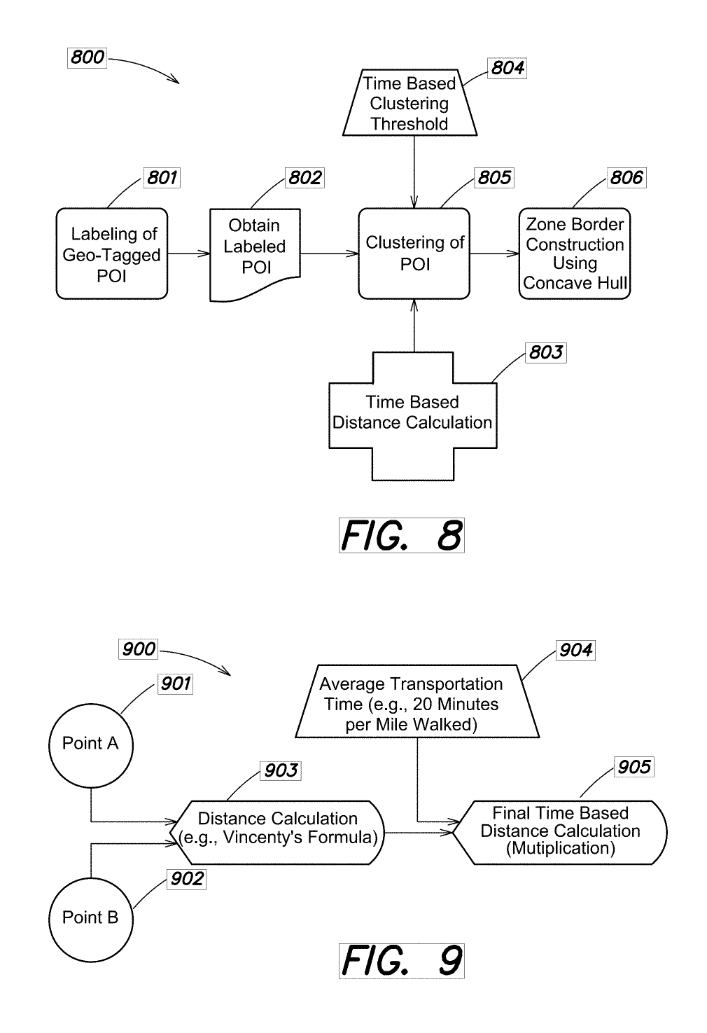

In some embodiments, constructing a spatial activity zone may include one or more of the following steps. FIG. 8 shows illustrative steps for determining a spatial zone according to steps 801-806 below:

(1) Labeling of geo-tagged Points Of Interest (POIs) (801)

(2) Obtaining Collection of Labeled and geo-tagged POIs (802)

(3) Time based distance calculation (803)

(4) Time based clustering threshold (804)

(5) Clustering of POIs (using time based distance calculations) (805)

(6) Defining boundary of spatial zones (806)

In some embodiments, step 1 (801) comprises labeling a collection of geo-tagged POIs with a label that defines a related set of POIs (e.g., “nightlife,” “athleisure,” “family,” “foodie,” or another suitable label). In some embodiments, a geo-tagged POI is associated with and/or includes geographical and/or geospatial information, such as latitude and longitude coordinates, altitude, bearing, distance, accuracy data, place names, a time stamp or other suitable information.

In some embodiments, step 2 (802) comprises obtaining the labeled set of POIs.

In some embodiments, step 3 (803) comprises determining a “Time based distance calculation” which measures the relationship between any two geo-tagged POIs based on how long it takes to get from one POI to another. This may be based on time spent walking, driving, commuting via train, etc.

In some embodiments, step 4 (804) comprises determining a time based threshold (e.g., “5 minutes”) that forms a key part of the clustering algorithm and determines the maximum amount of time it takes to get from an arbitrary point within a zone to another point within the same zone.

In some embodiments, step 5 (805) comprises performing a clustering algorithm that produces groupings (clusters) of labeled POIs by using the time-based distance calculation together with the time based clustering threshold. The clustering algorithm may be a k-means clustering algorithm, a hierarchical clustering algorithm, a distribution-based clustering algorithm, a density-based clustering algorithm, or another suitable clustering algorithm.

In some embodiments, step 6 (806) takes the groupings produced by step 5 and determines a boundary for each grouping enclosing the points within the grouping by drawing the polygon representing the 2-D concave hull of set of points.

Labeling of Geo-Tagged POIs (801)

Geo-tagged POIs may include POIs (e.g., bars, restaurants, stores, establishments, parks, etc.) and an associated set of Latitude and Longitude coordinates. Labeling such a geo-tagged POI may be referred to as associating a Label to the POI. These labels may range from specific (e.g., “craft cocktails”) to general (e.g., “family”). For the purposes of spatial zone construction, defining and applying a set of labels may be motivated by understanding why a certain set of POIs might be of interest as a group. As a counter-example, “orthodontic surgeon” may make a poor choice of label, as one does not generally need to walk from orthodontic surgeon to orthodontic surgeon. In contrast, “nightlife” may be an appropriate label, as people will often visit multiple establishments (such as restaurants, bars, late night bodegas, pool halls, etc.) over the course of a night on the town. Thus, grouping such establishments based on how long it takes to get from one establishment to another may be of interest.

The labeling of a geo-tagged POI may be done using a variety of techniques, in isolation or in combination, including (but not limited to):
User labeling: This may be done by a user, an expert, or another suitable entity using a Content Management System (CMS) or by directly manipulating digital files (such as JSON, CSV, etc.) either via text editor or other applications (such as MICROSOFT EXCEL, GOOGLE SHEETS, etc.).
Algorithmic labeling using available metadata and business rules: There may be a wide variety of metadata about POIs that is publicly available from sources, such as GOOGLE, YELP, THE YELLOW PAGES, FOURSQUARE, and other suitable sources. This metadata may take the form of labels itself, but may also include numerical fields such as opening hours. The name of a POI is also a type of metadata pertaining to that POI. POIs may be labeled via the construction of algorithmically implemented business rules. For example, a given collection of POIs having metadata associated with them may include labels such as “bar,” “pool hall,” and “restaurant.” Some or all POIs labeled with such labels may also have metadata pertaining to opening hours available. The label “Nightlife” may be applied to such a group of POIs having available data based on the following business logic:
   If a POI has the “bar” or “pool hall” label, it should be labeled with “nightlife.”
   If a POI has the “restaurant” label and is open past 11 pm for at least 4 out of 7 days of the week, it should be labeled with “nightlife.”
Algorithmic labeling using Natural Language Processing: Natural Language Processing (NLP) may be used in a variety of ways to label POI. A simple example may involve algorithmically examining the names of POI to determine whether a label should be applied. For example, consider how one might determine whether an establishment is a Yoga studio. In one implementation, this determination may be performed by the system as follows:
1. Let POI_name be the name of the POI.
2. Construct POI_name_array, a one dimensional array of strings where each string in the array corresponds to a single word of the POI name. For example, the POI_name_array representing the POI “Yoga Vida” (a yoga studio in New York City) may be a two item array: [“Yoga,” “Vida”].
3. Test whether a predetermined set of strings is contained within the POI_name_array. For example, the predetermined set of strings may be stored in an array such as [“Yoga,” “yoga,” “Bikram,” “bikram,” “Vinyasa,” “vinyasa”] and referred to as yoga_test_array.
4. For each item in yoga_test_array, test whether there are any strings in POI_name_array that are equal to any of the strings in yoga_test_array. If so, label the POI as a yoga studio.

A more complex example may involve algorithmically analyzing a corpus of text pertaining to a POI to produce a label. For example, topic modeling may be applied to a set of restaurant reviews pertaining to a POI to determine if the POI should be labeled as “hipster.”

In one implementation, this determination may be performed by the system as follows:
1. Construct a topic model by ingesting a corpus of restaurant reviews of a large collection of restaurants (for example, all of the restaurant reviews of restaurants in New York City written over the past 5 years by the New York Times).
2. A “topic” within this restaurant topic model may be a cluster of words or groupings of words that generally pertain to hipster culture, for example, “craft cocktails,” “craft beers,” “natural wine,” “local,” “artisanal,” “fermented,” and other suitable topics. In some embodiments, the labeling of such a cluster as “hipster” is based on input from a user, an expert, or another suitable entity.
3. For a given candidate POI, collect all of the restaurant reviews pertaining to the POI.
4. Algorithmically ingest these reviews and, from them, construct a bag of words (BOW), a matrix that represents word frequency within the reviews.
5. Normalize this bag of words in relation to a variety of factors such as the number of restaurant reviews about the POI ingested or the total number of words ingested about the POI.
6. Test whether the words in our “hipster” topic are over or under-represented in the normalized bag of words. The determination of over/under representation of hipster words may be done in relation to a human-determined threshold. If the normalized BOW corresponding to a POI is determined to have an over-representation of hipster words, apply the “hipster” label to the POI in question.
   Algorithmic labeling using Image Recognition: Image Recognition technology may be used to algorithmically apply labels to POI if there are photos or other visual representations of each POI within the collection of POI. For example, the tag “hipster” may be applied to a POI based on visual representations of the POI including (but not limited to) exterior photography, interior photography, logo design, website design, etc. of said POI.

Collection of Labeled and Geo-Tagged POIs (802)

This step includes obtaining a collection of labeled and geo-tagged POIs resulting from step 1. In some embodiments, this collection may be stored digitally in a single file such as a text, JSON or CSV, or, in some embodiments, this collection may be stored as a collection of documents using a variety of database technologies (SQL, Hadoop, etc.).

Time Based Distance Calculation (803)

The step for time based distance calculation produces, given a pair of geo-tagged POIs and a mode of transport (e.g., walking, biking, running, etc.) a number reflecting the amount of time it takes to get from one POI to the other. There are a variety of methods for calculating this amount of time that range in accuracy. For example, a time estimate for how long it takes to walk from POI_A to POI_B may be produced as follows (also illustrated in FIG. 9):
1. Calculate the distance from POI_A (901) to POI_B (902) using a formula such as Vincenty's formula (903) for calculating the distance (in miles) between two points represented by latitude/longitude coordinates.
2. Multiply (905) this distance by an average walking time per mile (904) (for example, 20 minutes per mile).

Time Based Clustering Threshold (804)

The step for time based clustering threshold determines the maximum amount of time it takes to get from an arbitrary point within a zone to another point within the same zone. In some embodiments, the time based clustering threshold is a key component of the clustering of POIs. It should be noted that, in some embodiments, this threshold is dependent on the mode of transport established in the time based distance calculation (e.g., walking, running, cycling, driving, etc.).

In some embodiments, the time based clustering threshold is user-determined via a graphical user interface, where a user may use a number slider to vary the threshold. For example, a user may vary a time based clustering threshold, such as a “walking time threshold,” from between 2 and 20 minutes of walking time between points of interest within a spatial zone, or from between another suitable range of walking time between points of interest within the spatial zone.

In some embodiments, the time based clustering threshold is determined algorithmically. For example, the system may receive data collected by a smartwatch or another suitable device worn by one or more users. Based on the data, the system may determine the time based clustering threshold as a function of one or more of the average, median, mode, range, minimum, and/or maximum distance travelled by the users during the course of a typical walk (e.g., during a typical “night on the town,” a typical “shopping trip,” or another suitable event). In another example, the system may receive data from a bike share service, such as CITIBIKE, and determine the time based clustering threshold as a function of one or more of the average, median, mode, range, minimum, and/or maximum distance a typical user rides continuously between two points of interest.

Clustering of POIs (805)

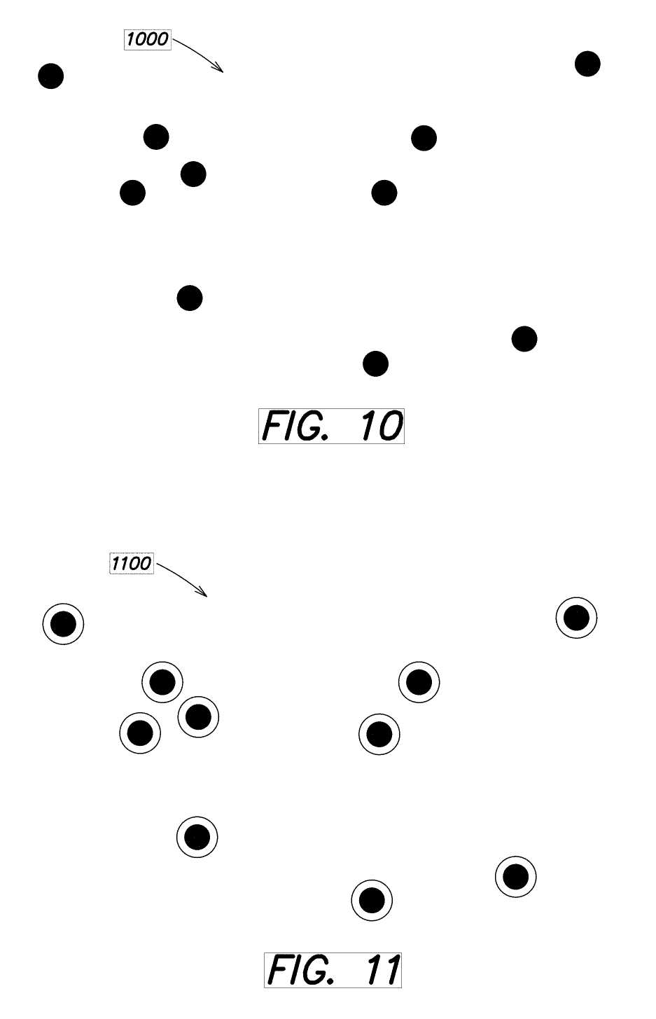

Once a set of geo-tagged POIs have been labeled, the system may apply a clustering algorithm to all the POIs to which the same label has been applied to produce spatial zones representing continuous spatial areas related to said label. The clustering algorithm may be applied based on the time based distance calculations, as illustrated in FIGS. 10-14. In some embodiments, the system may perform the following:

Let P represent a collection of POIs to which the same label has been applied

Let D(p1, p2) be the number produced by the time based distance calculation between two POIs p1 and p2

Let T be a time based clustering threshold
Construct a collection of clusters C, where each p in P is placed into a unique cluster c
For each p(i) in P:
   Let C_p(i) be an empty collection of clusters
   For each cluster c(k) in C:
      For each POI p(j) in c(k):
         If D(p(i), p(j))<=T for any p(j) in c(k), add c(k) to C_p(i) (C_p(i) now represents the collection of clusters that p(i) is less than T away from)
   Construct an empty cluster n_c
   For each c in C_p(i):
      Remove c from C
      For each p(j) in c:
         Add p(j) to n_c
   Add n_c to C

FIGS. 10-14 show diagrams of an example process for clustering a set of points of interest into groupings of points of interest sharing a common label according to one embodiment. Let P represent a collection of POIs to which the same label has been applied (represented by FIG. 10). Construct a collection of clusters C, where each p in P is placed into a unique cluster c. (clusters represented by FIG. 11).

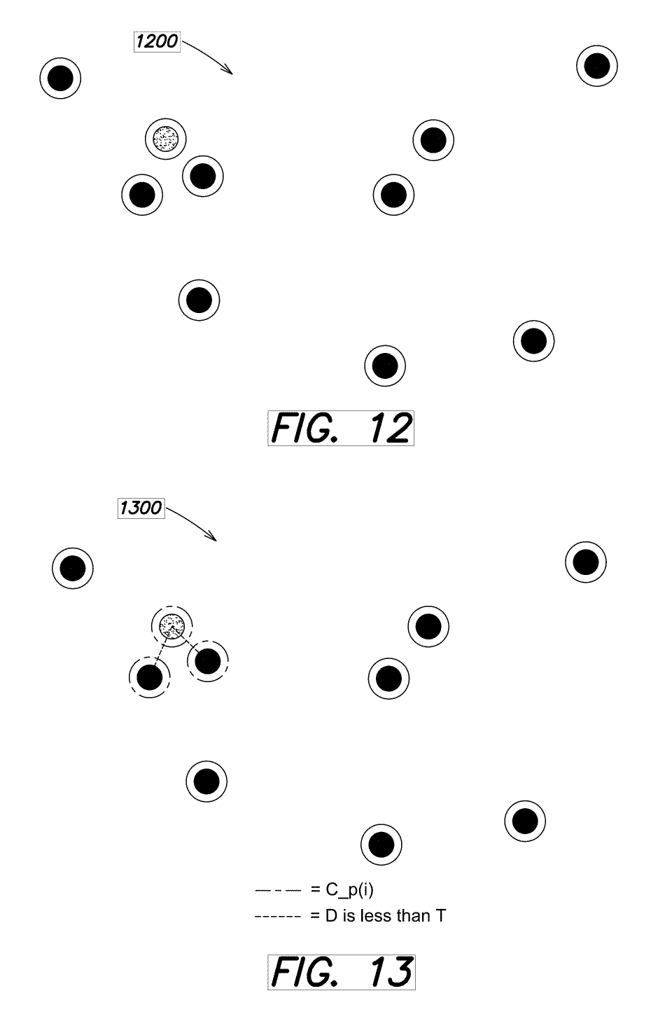

For each p(i) in P, Let C_p(i) be an empty collection of clusters (represented by FIGS. 12 and 13).
For each cluster c(k) in C:
   For each POI p(j) in c(k):
      If D(p(i), p(j))<=T for any p(j) in c(k), add c(k) to C_p(i) (C_p(i) now represents the collection of clusters that p(i) is less than T away from)
Construct an empty cluster n_c
For each c in C_p(i):
   Remove c from C
   For each p(j) in c:
      Add p(j) to n_c
Add n_c to C

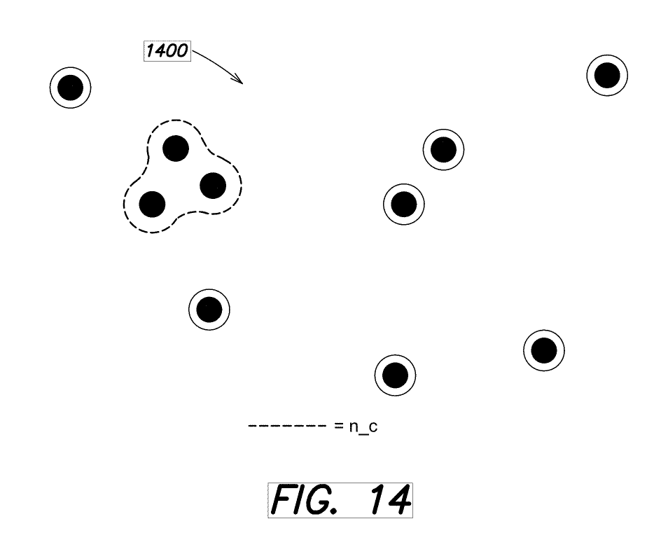

At the completion of the algorithm, C represents a collection of groups of POIs any of whose members are at most T away from another member of the group (FIG. 14).

In some embodiments, certain restrictions may be placed on the minimum number of POIs that a cluster must contain to be considered a zone. For example, a zone may be defined as having at least three distinct POIs. In this case, all clusters with less than three distinct POIs may be discarded.

Defining Boundaries of Spatial Zones (806)

The boundary of a spatial zone may be defined as the minimum envelope that contains all POIs within the given zone. In one implementation, the boundary of a spatial zone may be defined by constructing the Concave Hull of the set of points contained by a given zone Z. In some embodiments, the Concave Hull of the set of points, each having corresponding latitude and longitude coordinates, contained by a given zone Z is determined according to the following:
1. Find the point with the lowest latitude coordinate and make it the current one.
2. Find the k-nearest points to the current point.
3. From the k-nearest points, select the one which corresponds to the largest right-hand turn from the previous angle.
4. Check if by adding the new point to a growing line string, it does not intersect itself. If it does, select another point from the k-nearest or points restart with a larger value of k.
5. Make the new point the current point and remove it from the list.
6. After k iterations, add the first point back to the list.
7. Loop to step 2.

Further details regarding computing the Concave Hull may be found in Moreira, A. and Santos, M Y., 2007, Concave Hull: A K-nearest neighbors approach for the computation of the region occupied by a set of points, which is incorporated by reference herein.

In some embodiments, a buffer may be added to the edges of the zone. For example, the buffer may help the Concave Hull in discriminating points close to the edges of the zone, in addition to the points inside of the zone. The width of this buffer may be defined by the time based threshold T, so that any point contained by the zone boundary is at most T away from a POI within the zone.

Example Computer Architecture

One example implementation of the described systems and methods is shown in FIG. 15. In particular, system 1500 may include one or more processors 1501 that are operable to construct one or more spatial zones (e.g., element 1504). Such information may be stored within memory or persisted to storage media. In some embodiments, processors 1501 may receive one or more sources of point-of-interest data 1502 that is indicative of one or more points of interest. In some embodiments, processors 1501 may receive and/or generate labeled points of interest 1503 according to the described systems and methods. Processors 1501 may be configured to execute the described systems and methods to construct one or more spatial zones from point-of-interest data 1502 and/or labeled points of interest 1503.

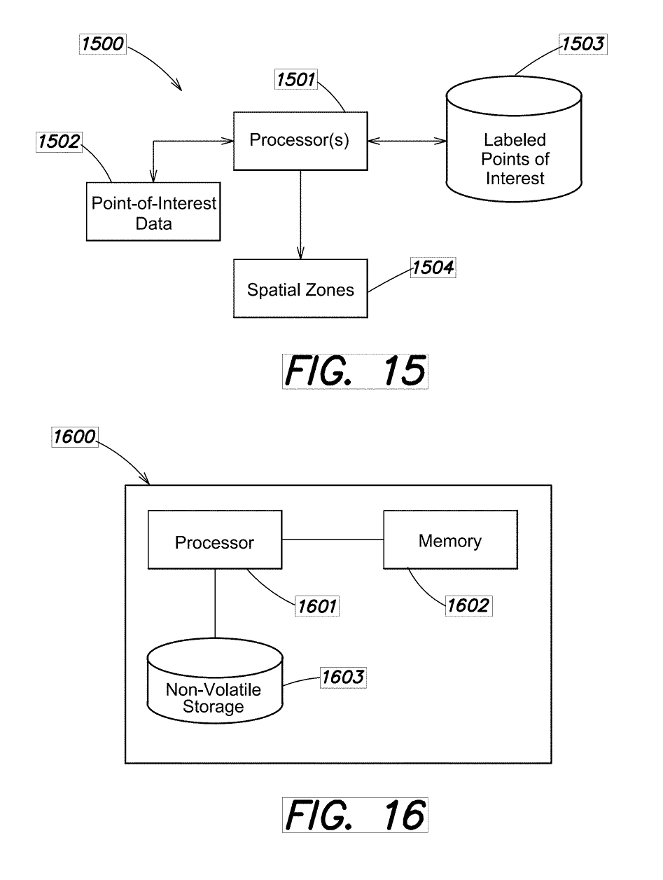

An illustrative implementation of a computing device 1600 that may be used in connection with any of the embodiments of the disclosure provided herein is shown in FIG. 16. The computing device 1600 may include one or more processors 1601 and one or more articles of manufacture that comprise non-transitory computer-readable storage media (e.g., memory 1602 and one or more non-volatile storage media 1603). The processor 1601 may control writing data to and reading data from the memory 1602 and the non-volatile storage device 1603 in any suitable manner. To perform any of the functionality described herein, the processor 1601 may execute one or more processor-executable instructions stored in one or more non-transitory computer-readable storage media (e.g., the memory 1603), which may serve as non-transitory computer-readable storage media storing processor-executable instructions for execution by the processor 1601.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

All definitions, as defined and used herein, should be understood to control over dictionary definitions, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing,” “involving,” and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A system for constructing a spatial zone, the system comprising:
at least one computer hardware processor;
at least one non-transitory computer-readable storage medium storing processor-executable instructions that, when executed by the at least one computer hardware processor, cause the at least one computer hardware processor to perform:
obtaining point-of-interest data indicating a label and a location for each of one or more points of interest in a plurality of points of interest;
determining, using the point-of-interest data, commute times among at least some of the plurality of points of interest, wherein a first commute time between two points of interest of the at least some of the plurality of points of interest indicates an estimated amount of time for commuting between the two points of interest for a particular mode of transportation;
clustering, using the commute times and labels indicated by the point-of-interest data, the plurality of points of interest into a set of point-of-interest clusters, wherein substantially all points of interest in each cluster in the set have a common label; and
determining a set of spatial zones corresponding to the set of point-of-interest clusters by identifying a spatial boundary for each cluster in the set of point-of-interest clusters.

2. The system of claim 1, wherein the particular mode of transportation is one of walking, running, driving, riding a bicycle, and taking public transportation.

3. The system of claim 1, wherein the location includes one or more of global positioning satellite (GPS) location, a latitude coordinate, and a longitude coordinate.

4. The system of claim 1, wherein the clustering uses one of a k-means clustering algorithm, a hierarchical clustering algorithm, a distribution-based clustering algorithm, and a density-based clustering algorithm.

5. The system of claim 1, wherein obtaining the point-of-interest data comprises
receiving metadata for a respective point of interest, and
applying one or more business rules to the received metadata to determine the label for the respective point of interest.

6. The system of claim 1, wherein obtaining the point-of-interest data comprises
receiving metadata for a respective point of interest,
parsing, using natural language processing, the metadata, and
determining the label for the respective point of interest based on the parsed metadata.

7. The system of claim 1, wherein obtaining the point-of-interest data comprises
generating a topic model based on a corpus of text relating to the plurality of points of interest,
determining a topic within the topic model, wherein the topic includes a grouping of one or more words relating to the plurality of points of interest,
identifying a portion of the corpus of text relating to the respective point of interest,
constructing, based on the portion of the corpus of text, a bag of words representing word frequency within the portion of the corpus of text,
normalizing the bag of words with respect to a number of occurrences in the corpus of text relating to the respective point of interest,
assigning the topic as a label for the respective point of interest based on the topic being represented above a specified threshold in the normalized bag of words.

8. The system of claim 1, wherein obtaining the point-of-interest data comprises determining the label for a respective point of interest based on a visual representation of the respective point of interest.

9. The system of claim 6, wherein the visual representation includes one or more of exterior photography, interior photography, logo design, and website design.

10. The system of claim 1, wherein determining the first commute time comprises
calculating a distance between the two points of interest,
multiplying the distance with an average transportation time for the particular mode of transportation to determine the first commute time.

11. The system of claim 8, wherein the calculation of the distance is based on Vincenty's formula.

12. The system of claim 1, wherein determining the set of spatial zones comprises including a buffer to one or more edges of the spatial boundary, wherein a width of the buffer is determined such that a point in the spatial boundary is at most a specified threshold time from a point of interest within the spatial boundary.

13. The system of claim 1, wherein the spatial boundary is a minimum envelope that includes all points of interest within the respective spatial zone.

14. The system of claim 12, wherein the minimum envelope that includes all points of interest within the respective spatial zone is a concave hull of all points of interest within the respective spatial zone.

15. The system of claim 1, wherein the processor-executable instructions further cause the at least one computer hardware processor to perform:
determining a time-based clustering threshold for a maximum time to commute from an arbitrary point within a spatial zone to another arbitrary point within the spatial zone, wherein clustering the plurality of points of interest includes clustering, using the commute times, labels indicated by the point-of-interest data, and the time-based clustering threshold, the plurality of points of interest into the set of point-of-interest clusters.

16. The system of claim 1, wherein the determined set of spatial zones are input into a machine learning model to predict one or more spatial zones suitable for a real estate company.

17. A method for constructing a spatial zone, comprising:
using at least one computer hardware processor to perform:
obtaining point-of-interest data indicating a label and a location for each of one or more points of interest in a plurality of points of interest;
determining, using the point-of-interest data, commute times among at least some of the plurality of points of interest, wherein a first commute time between two points of interest of the at least some of the plurality of points of interest indicates an estimated amount of time for commuting between the two points of interest for a particular mode of transportation;
clustering, using the commute times and labels indicated by the point-of-interest data, the plurality of points of interest into a set of point-of-interest clusters, wherein substantially all points of interest in each cluster in the set have a common label; and
determining a set of spatial zones corresponding to the set of point-of-interest clusters by identifying a spatial boundary for each cluster in the set of point-of-interest clusters.

18. At least one non-transitory computer-readable storage medium storing processor-executable instructions that, when executed by the at least one computer hardware processor, cause the at least one computer hardware processor to perform:
obtaining point-of-interest data indicating a label and a location for each of one or more points of interest in a plurality of points of interest;
determining, using the point-of-interest data, commute times among at least some of the plurality of points of interest, wherein a first commute time between two points of interest of the at least some of the plurality of points of interest indicates an estimated amount of time for commuting between the two points of interest for a particular mode of transportation;
clustering, using the commute times and labels indicated by the point-of-interest data, the plurality of points of interest into a set of point-of-interest clusters, wherein substantially all points of interest in each cluster in the set have a common label; and
determining a set of spatial zones corresponding to the set of point-of-interest clusters by identifying a spatial boundary for each cluster in the set of point-of-interest clusters.
